(19) United States
(12) Patent Application Publication
(10) Pub. No.: US 2006/0145627 A1
(43) Pub. Date: Jul. 6, 2006

(54) Continuous current control circuit modules of series string bulbs

(76) Inventor: Mei-Ling Peng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/025,954

(22) Filed: Jan. 3, 2005

(51) Int. Cl. F21S 4/00

(52) U.S. Cl. 315/185 S

(57) ABSTRACT

The invention relates to a continuous current control circuit module of series string bulbs, which can maintain the normal current and voltage across each of the bulbs when any of series connected bulbs burn out. The string includes a shunt in every bulb assemblies, which includes a triode with resistors and is parallel connecting related to the bulb. The shunt will thus provide a secure electrical connection of the light string whenever any bulb is burn out or broken.

### FIELD OF THE INVENTION

The present invention relates to an improvement of a continuous current control circuit module of series string bulbs, which includes a secure shunt for maintaining electrical connection of the light string effectively.

### BACKGROUND OF THE INVENTION

In prior art, continuous current control circuit modules of series string bulbs in order to maintain their electrical connection whenever any bulb assembly is broken or loosen have different structures. One is to provide an elastic metal slice in every bulb assembly being parallel connected to the bulb. If the bulb is broken, the metal slice becomes a shunt for connecting the series connected light string. Another design, in U.S. Pat. No. 6,084,357, discloses a string in which all of the bulb filaments in the set are individually provided with a non-avalanche shunt circuit to replace the elastic metal slice. The shunt circuit includes two or more silicon diodes. Since the diode is directional, it must be connected in correct direction. If there is any mistake in connection, the shunt will be out of work. Moreover, when the diode is used, the temperature will be increased rapidly to about centigrade 64 degree, that could cause the solved of the holder of the bulb and even leads a fire danger.

### SUMMARY OF THE INVENTION

The present invention is to provide an improved continuous current control circuit module of series string bulbs having secure shunt, which includes one triode with resistor in each circuit module. Now, accompanying with the following drawings, the character of the present invention will be described here and after.

### BRIEF DESCRIPTION OF THE DRAWINGS

FIG. 1 is a schematic view showing an electrical circuit according to the present invention.

FIG. 2 is a cross-sectional plan view showing a bulb assembly according to the present invention.

FIG. 3 is a schematic view showing a modified electrical circuit according to the present invention.

FIG. 4 is a schematic view showing another modified electrical circuit according to the present invention.

### DETAILED DESCRIPTION OF THE PREFERRED EMBODIMENT

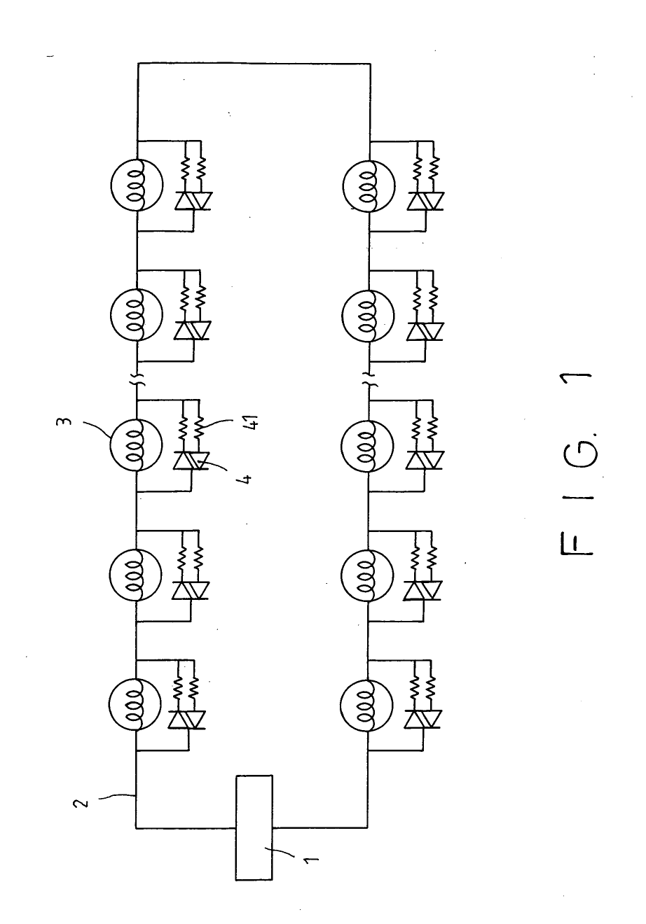

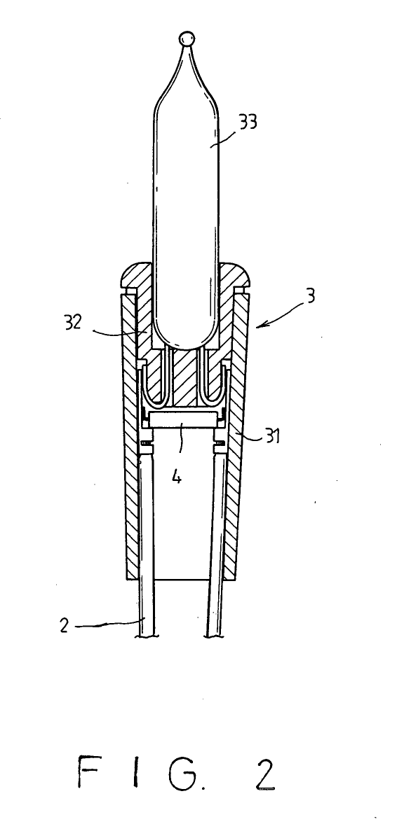

Please refer to FIG. 1, the present invention relates to an improvement of a continuous current control circuit module of series string bulbs, which includes a power source (1) and a main electrical wire (2) connecting with many bulb assemblies (3), such as 50 sets or 100 sets. Each bulb assembly (3) includes a shell (31), a bulb holder (32), and a bulb (33), as shown in FIG. 2. The improvement of the present invention is to provide a secure shunt having a triode (4) to connect within the bulb assembly (3) in parallel to the bulb (33). Further, two resistors (41) are capable to be connected in the secure shunt that provides a resistance slightly higher than the resistance of the bulb (33).

In use, the triode (4) in the shunt provides an effective electrical connection for the series connected light string. When the bulb (33) is used in normal, the string works normally. If the bulb (33) is burn out or broken, the triode (4) keeps the circuit in electrical connection through the shunt and maintains the series connected light string worked normally as usual. At the same time, in accompany with the effect of the resistors (34), the bulb assembly (3) remains a low temperature, up to centigrade 42 degree, that prevents the drawback of the said conventional art.

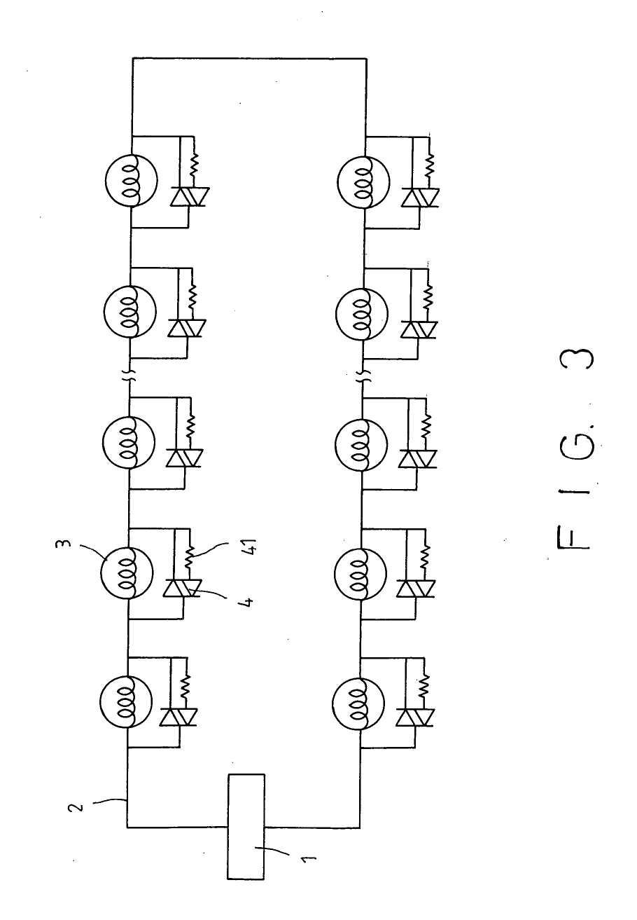

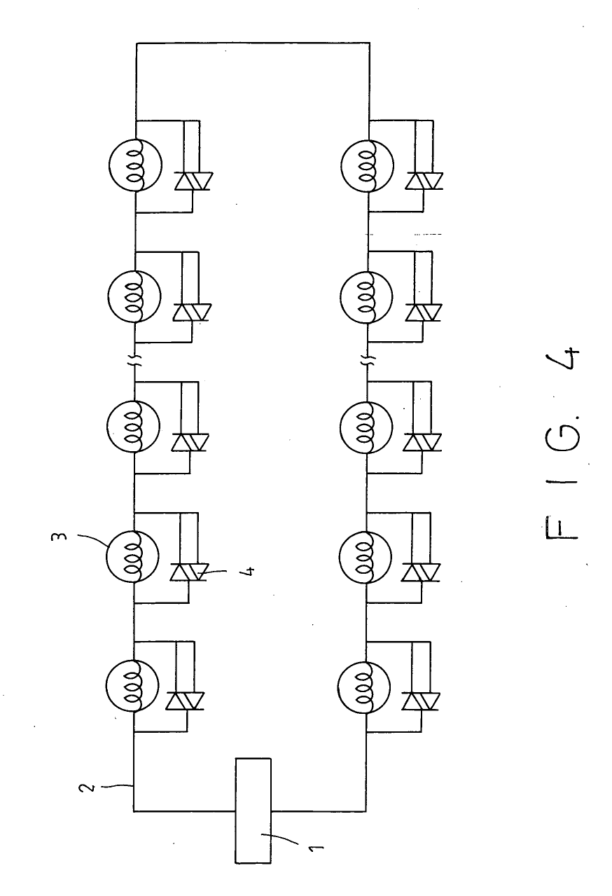

In above application, the shunt includes two resistors (41) is only an exemplary. In fact, one resistor (FIG. 3) or none resistor (FIG. 4) is available in the shunt of the present invention, which can obtain the predicted purpose as above description and is better than ever.

I claim:

1. A continuous current control circuit module of series string bulbs including a power source and a main electrical wire connecting with many bulb assemblies, wherein each bulb assembly including a shell, a bulb holder, and a bulb; the improvement is in that a secure shunt having a triode being provided to connect within the bulb assembly in parallel to the bulb, and two resistors being connected in the secure shunt that provides a resistance slightly higher than the resistance of the bulb.

2. A continuous current control circuit module of series string bulbs as claimed in claim 1, wherein the secure shunt includes a triode and only one resistor.

3. A continuous current control circuit module of series string bulbs as claimed in claim 1, wherein the secure shunt includes only a triode.
